(19) United States
(12) Patent Application Publication
(10) Pub. No.: US 2024/0353856 A1
(43) Pub. Date: Oct. 24, 2024

(54) MATERIAL CATEGORISATION AND TRANSPORTATION SYSTEMS AND METHODS

(71) Applicant: Technological Resources Pty. Limited, Melbourne (AU)

(72) Inventors: Florian Andreas Oppolzer, Nundah (AU); Peter Siew Hun Mah, Como (AU)

(21) Appl. No.: 18/686,052

(22) PCT Filed: Aug. 25, 2022
(86) PCT No.: PCT/AU2022/051010

§ 371 Date: Feb. 23, 2024

(30) Foreign Application Priority Data
Aug. 25, 2021 (AU) 2021221760
Aug. 25, 2021 (AU) 2021221812
Aug. 25, 2021 (AU) 2021221826
Aug. 25, 2021 (AU) 2021221840

(51) Int. Cl. G05D 1/60; B65G 63/00; B65G 67/04; E21C 41/26; G05D 105/05

(52) U.S. Cl. CPC G05D 1/60; B65G 63/008; B65G 67/04; E21C 41/26; B65G 2201/045; B65G 2203/0208; B65G 2203/042; G05D 2105/05

(57) ABSTRACT

There is provided a material categorisation and transportation system including a plurality of mine vehicles for transporting material within a mine site from a first location in the form of a blast site to a second location. The system includes a sensing device for actively sensing chemical property characteristics of raw blasted mined material such that the raw material can be categorised into a plurality of material categories based on the sensed characteristics. The system further includes a loading device located at blast site for loading the raw material into a predefined one of the mine vehicles based on material category for transportation to the second location. The system is such that each of the mine vehicles only carries raw material of a predetermined one of the material categories.

### RELATED APPLICATIONS

This application is related to: Australian Patent Application No. 2021221812 entitled “Methods and systems for mining” having a filing date of 25 Aug. 2021; Australian Patent Application No. 2021221760 entitled “Transporting a mined material” having a filing date of 25 Aug. 2021; Australian Patent Application No. 2021221826 entitled “Material categorisation and transportation systems and methods” having a filing date of 25 Aug. 2021; Australian Patent Application No. 2021221840 entitled “Method and apparatus for coordinating loading of haul vehicles” having a filing date of 25 Aug. 2021; co-pending International patent application entitled “Methods and systems for mining” having a filing date of 25 Aug. 2022; co-pending International patent application entitled “Transporting mined material” having a filing date of 25 Aug. 2022; co-pending International patent application entitled “Method and apparatus for coordinating loading of haul vehicles” having a filing date of 25 Aug. 2022, and co-pending International patent application entitled “A Mining Operation” having a filing date of 25 Aug. 2022. The contents of all of these applications is incorporated in full herein by way of cross reference.

### TECHNICAL FIELD

The present disclosure relates to material categorisation, loading and transportation. The present disclosure has applications to material categorisation and transportation processes in the field of mining.

While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

There are many different processes and systems used in the mining industry, and in particular to mining raw materials. Which of these processes and systems to use depends on a number of factors including:
The type of material to be mined (for example lithium, borates, bauxite, alumina, cobalt iron ore, etc.); and
The type of mine (surface mine such as open-cut, underground mine such as those using tunnels or declines, etc.)

Depending on the type of material, type of mine and any other pertinent factors, certain mining processes may be more suitable to maximise yield and efficiency.

One mining process used in surface mines to mine materials such as coal and iron ore, is blast mining. Blast mining essentially uses strategically placed controlled explosives on a prepared area of a mine site, that are detonated in order to break up raw materials to enable ease of transportation and further processing.

In known blast mine operations, mined material is transported within an area being mined and also from an area being mined. Mined material is transported to other areas within the mine such as: stockpiles; sorting facilities; crushing facilities; and transportation facilities. Mined material is transported to areas outside of the mine too, such as: ports; mineral processing plants; flotation plants; crushing/grinding mills; and concentrators.

Over the years, the size of haul trucks has increased to the present size of ultra-class haul trucks. Ultra-class haul trucks are widely used for transportation of the blasted material from the blast site to the processing location. These trucks are most preferred within the industry due to their high load capacity as they are capable of hauling loads of over 120 to 150 tonnes, with most of able to haul approximately 200 to 240 tonnes, and the largest being able to haul loads of 300 tonnes or more. Given the cost of ultra-class haul trucks along with the large physical size and resultant relatively large load these trucks are able to haul, only a relatively small number of ultra-class haul trucks are used on a mine site. As such, it is imperative that these types of trucks are completely filled with material in order to facilitate efficiency of use of each truck.

### SUMMARY

It is an object of the present invention to overcome or ameliorate at least one of the disadvantages of the prior art, or to provide a useful alternative.

In accordance with a first aspect of the present invention there is provided a material categorisation and transportation system including:
at least two mine vehicles having an autonomous mode of operation for at least partially autonomously transporting material from a first location to a second location;
a sensing device for sensing characteristics of material such that the material is categorised into one of at least two material categories based on the sensed characteristics; and
a loading device located at the first location for loading material into the at least two mine vehicles based on the material category for transportation of the material to the second location, such that each of the at least two mine vehicles will only carry material of one of the at least two material categories.

In an embodiment, the sensing device is mounted to the loading device. In an alternate embodiment, the sensing device is integrally formed with the loading device.

In an embodiment, the sensing device is operatively associated with the loading device such that it can activate and deactivate the loading device from loading material.

In an embodiment, the mine vehicles are haul trucks. In a further embodiment, the haul trucks are of a conventional size range of vehicles that generally travel on public roads. In a yet further embodiment, the haul trucks have a load capacity in the range of 10 tonnes to 80 tonnes. In a yet further embodiment, the haul trucks have a load capacity in the range of 40 to 60 tonnes.

In an embodiment, the sensing device includes at least one sensor, the at least one sensor being one or more of the group including: Prompt Gamma Neutron Activation Analysis (PGNAA) sensor; microwave sensor; x-ray sensor; and magnetic induction sensor.

In an embodiment, the loading device one or more of the group including: an excavator; a dozer; a face shovel; a rope shovel; and a conveyor loader.

In an embodiment, the characteristics of material sensed by the sensor device include one or more of: concentration of a desired material; concentration of deleterious material; material moisture content; and material fragmentation size.

In an embodiment, the material is categorised into one of a plurality of material categories based on the sensed characteristics. In a further embodiment, the plurality of material categories includes: a high grade material category; a low grade material category; and a waste material category.

In an embodiment, the system includes at least three mine vehicles wherein:
a first one of the at least three mine vehicles receives material of the high grade material category;
a second one of the at least three mine vehicles receives material of the low grade material category; and
a third one of the at least three mine vehicles receives material of the waste material category.

In an embodiment, the first one of the at least three mine vehicles is configured to transport the material of the high grade material category to a high grade material location, the second one of the at least three mine vehicles is configured to transport the material of the low grade material category to a low grade material location, and the third one of the at least three mine vehicles is configured to transport the material of the waste material category to a waste material location.

In an embodiment, the first location is a blasted mine bench on a mine site.

In an embodiment, the second location is a stockpile associated with a materials processing site.

In an embodiment, the second location includes a plurality of sublocations such that each sublocation receives only materials of a certain one of the material categories.

In an embodiment, the loading device is configured to cease loading one of the at least two mine vehicles if the category of material that is sensed changes such that the one of the at least two mine vehicles is not loaded to its full capacity. In a further embodiment, the one of the at least two mine vehicles that is not loaded to its full capacity is configured to commence transportation of the material to the second location.

In an embodiment, the at least two mine vehicles are electric haul trucks.

In an embodiment, each of the at least two mine vehicles are able to be re-directed, prior to arrival at the second location, to a third location.

In an embodiment, the second location is not determined until after the at least two mine vehicles departs the first location.

In accordance with a second aspect of the present invention there is provided a material categorisation and transportation method including the steps of:
sensing, by a sensing device, characteristics of material at a first location; categorising the material into one of at least two material categories based on the sensed characteristics;
at the first location by a loading device, loading a predefined mine vehicle with material of a specific one of the at least two material categories, such that the predefined mine vehicle is only loaded with material of one of the at least two material categories; and
transporting, by the predefined mine vehicle, the material to a second location, wherein the predefined mine vehicle has an autonomous mode of operation and the transporting of material at least partially involves the mine vehicle being in the autonomous mode of operation.

In an embodiment, the sensing device is mounted to the loading device. In an alternate embodiment, the sensing device is integrally formed with the loading device.

In an embodiment, the sensing device is operatively associated with the loading device such that it can activate and deactivate the loading device from loading material.

In an embodiment, the mine vehicles are haul trucks. In a further embodiment, the haul trucks are of a conventional size range of vehicles that generally travel on public roads. In a yet further embodiment, the haul trucks have a load capacity in the range of 10 tonnes to 80 tonnes. In a yet further embodiment, the haul trucks have a load capacity in the range of 40 to 60 tonnes.

In an embodiment, the sensing device includes at least one sensor, the at least one sensor being one or more of the group including: Prompt Gamma Neutron Activation Analysis (PGNAA) sensor; microwave sensor; x-ray sensor; and magnetic induction sensor.

In an embodiment, the loading device one or more of the group including: an excavator; a dozer; a face shovel; a rope shovel; and a conveyor loader.

In an embodiment, the step of sensing characteristics of material includes sensing one or more of: concentration of a desired material; concentration of deleterious material; material moisture content; and material fragmentation size.

In an embodiment, the step of categorising the material includes categorising the material into one of a plurality of material categories based on the sensed characteristics. In a further embodiment, the plurality of material categories includes: a high grade material category; a low grade material category; and a waste material category.

In an embodiment, the step of loading the predefined mine vehicle with material of a specific one of the at least two material categories includes loading at least three predefined mine vehicles such that:
a first one of the at least three predefined mine vehicles receives material of the high grade material category;
a second one of the at least three predefined mine vehicles receives material of the low grade material category; and
a third one of the at least three predefined mine vehicles receives material of the waste material category.

In an embodiment, the first one of the at least three predefined mine vehicles is configured to transport the material of the high grade material category to a high grade material location, the second one of the at least three predefined mine vehicles is configured to transport the material of the low grade material category to a low grade material location, and the third one of the at least three predefined mine vehicles is configured to transport the material of the waste material category to a waste material location.

In an embodiment, the first location is a blasted mine bench on a mine site.

In an embodiment, the second location is a stockpile associated with a materials processing site.

In an embodiment, the second location includes a plurality of sublocations such that each sublocation receives only materials of a certain one of the material categories.

In an embodiment, the loading device is configured to cease loading of the predefined mine vehicle if the category of material that is sensed changes such that the predefined mine vehicle is not loaded to its full capacity. In a further embodiment, the predefined mine vehicle that is not loaded to its full capacity is configured to commence transportation of the material to the second location.

In an embodiment, the predefined mine vehicle is an electric haul truck.

In an embodiment, the predefined mine vehicle is able to be re-directed, prior to arrival at the second location, to a third location.

In an embodiment, the second location is not determined until after the predefined mine vehicle departs the first location.

In accordance with a third aspect of the present invention there is provided a material categorisation and transportation system including:
at least two electric haul trucks for transporting material from a first location to a second location;
a sensing device for sensing characteristics of material such that the material is categorised into one of at least two material categories based on the sensed characteristics; and
a loading device located at the first location for loading material into the at least two electric haul trucks based on the material category for transportation of the material to the second location, such that each of the at least two electric haul trucks will only carry material of one of the at least two material categories.

In accordance with a fourth aspect of the present invention there is provided a material categorisation and transportation method including the steps of:
sensing, by a sensing device, characteristics of material at a first location;
categorising the material into one of at least two material categories based on the sensed characteristics;
at the first location by a loading device, loading a predefined electric haul truck with material of a specific one of the at least two material categories, such that the predefined electric haul truck is only loading with material of one of the at least two material categories; and
transporting, by the predefined electric haul truck, the material to a second location.

In accordance with a fifth aspect of the present invention there is provided a material categorisation and transportation system including:
at least one mine vehicle for transporting material from a first location to a second location;
a sensing device for sensing characteristics of material such that the material is categorised into one of at least two material categories based on the sensed characteristics; and
a loading device located at the first location for loading material into the at least one mine vehicle based on the material category for transportation of the material to the second location, such that the at least one mine vehicle will only carry material of one of the at least two material categories, wherein the loading device is configured to cease loading of the at least one mine vehicle if the category of material that is sensed changes such that the at least one mine vehicle is not loaded to its full capacity.

In an embodiment, the at least one mine vehicle that is not loaded to its full capacity is configured to commence transportation of the material to the second location

In an embodiment, the system includes at least two mine vehicles.

In accordance with a sixth aspect of the present invention there is provided a material categorisation and transportation method including the steps of:
sensing, by a sensing device, characteristics of material at a first location;
categorising the material into one of at least two material categories based on the sensed characteristics;
at the first location by a loading device, loading a predefined mine vehicle with material of a specific one of the at least two material categories, such that the predefined mine vehicle is only loading with material of one of the at least two material categories, wherein the loading device is configured to cease loading of the predefined mine vehicle if the category of material that is sensed changes such that the predefined mine vehicle is not loaded to its full capacity; and
transporting, by the predefined mine vehicle, the material to a second location.

In accordance with a seventh aspect of the present invention there is provided a material categorisation and transportation system including:
at least one mine vehicle for transporting material from a first location to a second location;
a sensing device for sensing characteristics of material such that the material is categorised into one of at least two material categories based on the sensed characteristics; and
a loading device located at the first location for loading material into the at least one mine vehicle based on the material category for transportation of the material to the second location, such that the at least one mine vehicle will only carry material of one of the at least two material categories, wherein the at least one mine vehicle is able to be re-directed, prior to arrival at the second location, to a third location.

In an embodiment, the system includes at least two mine vehicles.

In accordance with a eighth aspect of the present invention there is provided a material categorisation and transportation method including the steps of:
sensing, by a sensing device, characteristics of material at a first location;
categorising the material into one of at least two material categories based on the sensed characteristics;
at the first location by a loading device, loading a predefined mine vehicle with material of a specific one of the at least two material categories, such that the predefined mine vehicle is only loading with material of one of the at least two material categories; and
transporting, by the predefined mine vehicle, the material to a second location such that the predefined mine vehicle is able to be re-directed, prior to arrival at the second location, to a third location.

In accordance with a ninth aspect of the present invention there is provided a material categorisation and transportation system including:
at least two mine vehicles for transporting material from a first location to a second location;
a sensing device for sensing characteristics of material such that the material is categorised into one of at least two material categories based on the sensed characteristics; and
a loading device located at the first location for loading material into the at least two mine vehicles based on the material category for transportation of the material to the second location, such that each of the at least two mine vehicles will only carry material of one of the at least two material categories, wherein the second location is not determined until after the at least two mine vehicles departs the first location.

In accordance with a tenth aspect of the present invention there is provided a material categorisation and transportation method including the steps of:
sensing, by a sensing device, characteristics of material at a first location; categorising the material into one of at least two material categories based on the sensed characteristics;
at the first location by a loading device, loading a predefined mine vehicle with material of a specific one of the at least two material categories, such that the predefined mine vehicle is only loading with material of one of the at least two material categories; and
transporting, by the predefined mine vehicle, the material to a second location wherein the second location is not determined until after the predefined mine vehicles departs the first location.

Other aspects of the present disclosure are also provided.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may be in some appropriate cases. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

One or more embodiments of the present disclosure will now be described by way of specific example(s) with reference to the accompanying drawings, in which:

FIG. 1 is a block diagram of a material categorisation and transportation system according to an embodiment of the invention;

FIG. 2 is a schematic representation of an open cut mine including the system of FIG. 1;

FIG. 3 is a schematic representation of a mine vehicle of the system of FIG. 1;

FIG. 4 is a schematic representation of a loading device and a mine vehicle of the system of FIG. 1;

FIG. 5 is a representation of an alternate loading device of the system of FIG. 1;

FIG. 6 is a flow chart of the process of use of the system of FIG. 1.

### DETAILED DESCRIPTION

Where applicable, steps or features in the accompanying drawings that have the same reference numerals are to be considered to have the same function(s) or operation(s), unless the contrary intention is expressed or implied.

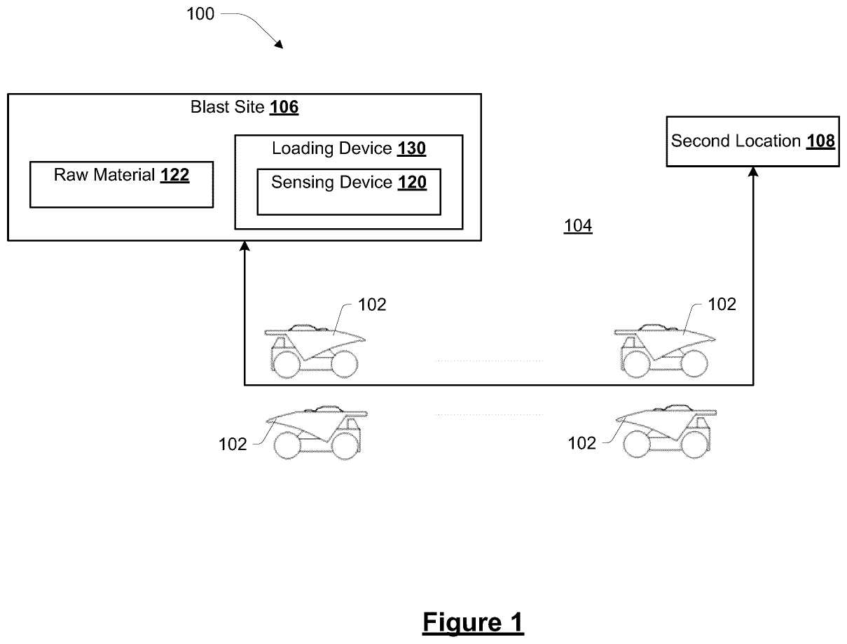

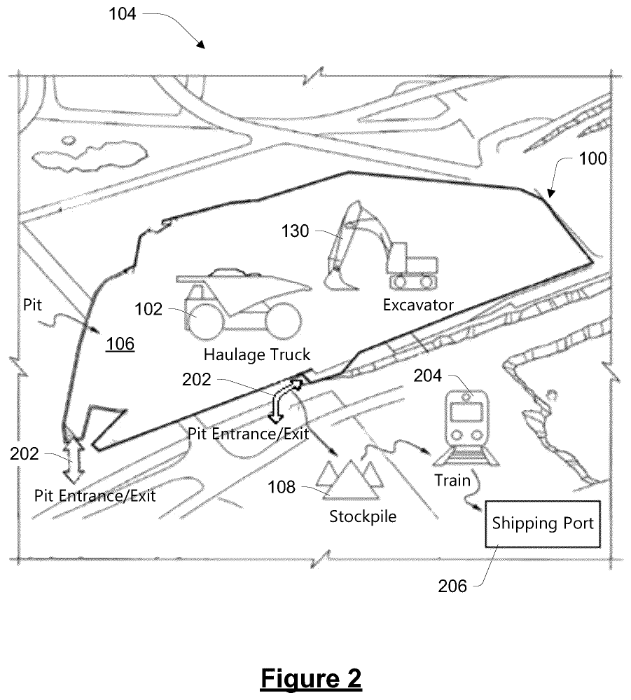

Referring initially to FIGS. 1 and 2, there is illustrated a material categorisation and transportation system 100 including a plurality of mine vehicles 102 for transporting material within a mine site 104 from a first location in the form of a blast site 106 to a second location 108. System 100 includes a sensing device 120 for actively sensing chemical property characteristics of raw blasted mined material 122 such that raw material 122 can be categorised into a plurality of material categories based on the sensed characteristics. System 100 further includes a loading system including at least one loading device 130 located at blast site 106 for loading raw material 122 into a predefined one of mine vehicles 102 based on material category for transportation to second location 108. The system is such that each of mine vehicles 102 only carries, or predominantly carries, raw material 122 of a predetermined one of the material categories.

Mine vehicles 102 are preferably Right Sized Autonomous Trucks (RSATs). RSATs are conventionally sized autonomous trucks of which their primary purpose is to transport material that is carried in an open box cargo bed. In other embodiments, trucks will have flat beds or chassis that are configured to transport one or more cargo containers. In preferred embodiments, mine vehicles 102 are electric vehicles. However, in other embodiments, mine vehicles 102 are petrol vehicles or diesel vehicles. The term “conventionally sized” as used herein refers to RSATs being around or within the conventional size range of trucks that generally travel on public roads. In some embodiments, conventional size trucks are defined by their width. In yet other embodiments, conventional size trucks are defined a combination of their width and their haulage capacity. The use of RSATs over the widely used ultra-class haul trucks will result in decreased hauling capacity on a per vehicle, per journey basis, as one ultra-class haul truck can carry the equivalent of two to three RSATs. However, RSATs are able to travel further distances without stopping as compared to ultra-class haul trucks which have a maximum safe range limit of 20 km to 30 km whilst loaded (due to issues such as tyres overheating), which often necessitates a relay type arrangement where a number of ultra-class haul trucks (with intermediate loaders to move material from one truck to the next) are required to move materials distances over the maximum safe range. Once the maximum safe range is reached, ultra-class haul trucks will need to dump their load entirely for a period of time in order to continue moving, before they can safely re-load again. If there is a need to transport materials distances greater than the maximum range of an ultra-class haul truck, for example a distance of 60 kms, a relay type arrangement is used whereby a first ultra-class haul truck will transport the material the first 30 kms and at that 30 km mark, dump the load and drive back to its point of origin (enabling the first ultra-class haul truck to cool off in order to reload again at the point of origin). At the 30 km mark, a single loading device such as an excavator will pick up the dumped material and load it into a second ultra-class haul truck that will transport the material the remaining 30 kms and dump the material at the 60 km destination point, after which the second ultra-class haul truck will return to the 30 km mark (whilst cooling off) to retrieve the next load from the first ultra-class haul truck. It will be appreciated that the dumping and reloading of material from one haul truck onto the ground and then onto another haul truck is known as ‘rehandling’. The range of RSATs is generally only limited by its fuel/power requirements and otherwise do not have a range limit. Further, RSATs, which can travel at a top average speed of 80 km/h to 100 km/h (and at least 40 km/h to 60 km/h on unsealed roads), are able to travel at greater speeds than ultra-class haul trucks, which will travel at much slower speeds as they are particularly affected by road conditions such as unsealed roads and significantly sloped roads. More significantly, RSATs are able to achieve their maximum speed in far lesser time than ultra-class haul trucks due to both quicker acceleration capabilities and being lesser negatively influenced by road conditions. For example, ultra-class haul trucks will be particularly slow travelling downhill at a safe speed due to their large mass which results in large forces if there is a collision and associated braking limitations of such large trucks. In terms of size of haul, a single RSAT is able to carry between 10 to 80 tonnes of material, or preferably 15 to 75 tonnes of material.

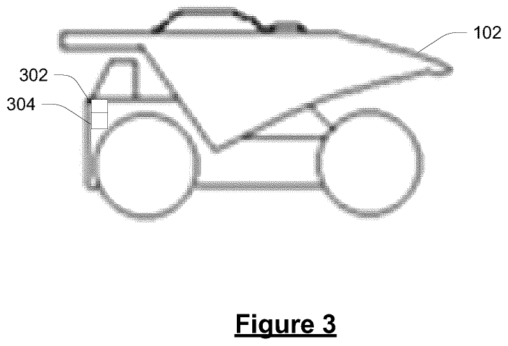

Referring to FIG. 3, the term “autonomous trucks” refers to vehicles that are preconfigured to autonomously travel along a predefined route between one or more locations, generally not deviating from that predefined route. It is important to note that the term “autonomous” will be known by those skilled in the art as being distinct from the term “automatic”, in that an “autonomous” vehicle is capable of making certain decisions for itself based on sensed inputs, whereas an “automatic” vehicle merely acts according to a predefined script. More specifically, an “automatic” vehicle generally requires constant human monitoring in order to deal with exception conditions, whereas an “autonomous” vehicle is able to respond to a number of exception conditions without human intervention. Further, an “autonomous” vehicle is able to actually identify and differentiate circumstances where human intervention is required (and send the appropriate alert and take action to safely continue with other actions or safely switch to an idle state) from those where human intervention is not required (and the above noted decision making capabilities are utilised).

Autonomous trucks are generally able to function without a dedicated driver or control person as they include a controller (in this case, each of mine vehicles 102 includes a respective controller 302) that is programmed to drive the truck in the preconfigured fashion. The controller will often include or be coupled to a communications unit (in this case, each of mine vehicles 102 includes a respective vehicle communications unit 304) that will be in wireless communication with a manned central controller of mine site 104, where that central controller (itself clearly including wireless communications functionality) monitors one or more autonomous trucks and where the autonomous travel and movement of the trucks can be altered as required by way of the central controller. It will be appreciated that, in other embodiments, the autonomous functionality of autonomous trucks includes movement that is not limited to predefined route. For example, an autonomous truck could be preconfigured to move freely within a designated area, and have the freedom and capability to alter its path within that area, for example, in response to sensed obstacles where a collision with such an obstacle may cause damage to the truck. In this case, the autonomous truck can be configured to avoid such a collision.

Autonomous vehicles often include multiple modes of operation, which includes: an autonomous mode of operation whereby the vehicle functions autonomously; and an operator controlled mode of operation whereby a human operator can manually control the vehicle. Operator controlled mode of operation includes: a remote controlled mode whereby an operator controls the vehicle from a remote location; and an onboard mode whereby an operator is present on or in the vehicle in order to manually control the vehicle.

It will be appreciated that a vehicle that is able to function in autonomous mode of operation is referred to as an autonomous vehicle, even though such vehicles can function non-autonomously (that is, manually controlled by a human operator).

An autonomous vehicle having multiple modes of operation is able to switch between those modes of operation as required or desired. The switching of modes can occur automatically or remotely. For example, when an autonomous vehicle identifies a circumstance where human intervention is required, it is able to switch to operator controlled mode with a default idle state and alert an operator to take control of the vehicle. It will also be appreciated that certain circumstance may warrant an automatic switching to autonomous mode from manual mode. For example, a vehicle that is being manually operated in operator controlled mode could sense the operator approaching a hazardous area such as a sheer drop and the vehicle may alert the operator as well as switch to autonomous mode to move the vehicle away from the hazardous area. The switching of modes can also occur manually. For example, an operator may observe a certain situation whilst a vehicle is in autonomous mode and wish to take immediate manual action so the operator can switch from autonomous mode to operator controlled mode to complete that action and then the operator can switch the vehicle back from operator controlled mode to autonomous mode so that the autonomous actions can continue.

Further, in some embodiments, vehicles may include “assist systems” where certain individual functions of a vehicle are automatically actuated. This may extend to any function of the vehicle including breaking or cruise control.

Whilst some preferred embodiments are directed to autonomous vehicles, it will be appreciated that in other embodiments, convention sized haul trucks that have a human driver either on board or controlling the truck be remote control are utilised.

Wireless communication between devices is by any appropriate standard or proprietary hardware and communications protocols, for example infrared, Bluetooth, WiFi; near field communications (NFC); Global System for Mobile Communications (GSM), Enhanced Data GSM Environment (EDGE), long term evolution (LTE), code division multiple access (CDMA—and/or variants thereof such as wideband CDMA), and/or any other possible wireless hardware/connectivity protocol.

In various embodiments, the payload capacity of each of mine vehicles 102 is determined by the sensing device 102 (in terms of how much of raw material 122 is loaded) and/or a dedicated sensor on each of mine vehicles 102.

It will be appreciated that in other embodiments, one or more of mine vehicles 102 are manually operated haul trucks.

As best illustrated in FIG. 2, blast site 106 is a blasted mine bench, that is, where the site where an explosive blast takes place and/or where the broken up (blasted) raw material 122 settles following the blast. It is noted that a mine bench is divided up into a plurality of bench “grade blocks”, those blocks being subregions of the bench. These blocks may be demarcated based on a number of factors, including the area size, the volume of anticipated raw material 122 following a blast, and the grading of raw material 122. Typically, a mine bench is 10 metres or more in both height and bench block size to accommodate large ultra-class haul trucks. However, where conventional sized haul trucks are utilised, the mine height and bench block size can be in the range of 2.5 to 10 metres or more preferably 5 to 10 metres. Furthermore, typically, the width of a bench is generally 70 metres or more in order to accommodate large ultra-class haul trucks. However, where conventional sized haul trucks are utilised, the width can be in the range of 30 to 70 metres or more preferably 40 to 60 metres. Additionally, the smaller width of the bench also allows for an overall steeper mine face profile, which would allow for mining deeper.

It will be appreciated that a pit is the entirety of the area from which ground has been excavated, and includes roads and walls, amongst others. The pit has dedicated entrance and exit points 202 and, further the pit has a pit floor, which is the bottom of the pit. Blast site 106 is located within the pit floor. However, in other embodiments, blast site 106 is located within the pit, but not within the pit floor.

Raw material 122 is categorised based on a grading of the material which is influenced by the concentration of valuable material within a given volume of raw material 122, in other words the concentration of target metal/mineral in the ore. For example, if iron is the desired material/target metal, if the sensed raw material 122 (ore) is found to have 70% iron mineralisation, it will be graded and then categorised appropriately based on this sensed concentration of iron.

Raw material 122 will also have a quality characteristic whereby the quality is influenced by the amount or concentration of other undesirable or deleterious material within a given volume of raw material 122, in other words the concentration of non-target minerals/elements in the ore. For example, in the case of iron ore, the quality of raw material 122 will be affected by the amount of phosphor. For example, a given volume of raw material 122, say iron ore, could be of a high grade in terms of concentration of iron but also of a low quality due to its concentration of phosphor. Similarly for the example of coal, where a given volume of raw material 122 could be of a high grade in terms of coal content but is also of a low quality due to its concentration of ash. In other embodiments, the categorisation of raw material 122 is affected by the concentration of undesirable or deleterious substances in a given volume of raw material 122. In the example of iron ore mining and processing, such deleterious material includes materials such as phosphor and sulphur, which will negatively affect processing methods and processing equipment. It will be appreciated that material that has a relatively low quality can be blended with material with a higher quality in order to increase the overall quality of a total volume of raw material 122 so that is it at or above a tolerable quality threshold. Such a blending process can occur at the time of loading a truck, for example, a truck will receive material from loading device 130 where a certain amount is of a relatively low quality and a certain amount is of a higher quality. The blending process can also occur at second location 108 where a specific dumping location can receive dumped material of a relatively low quality from one or more of mine vehicles 102 and dumped material of a higher quality from other one of mine vehicles 102 such that the combined average quality is above a tolerable quality threshold. Similarly, it will also be appreciated that blending can be performed in a similar manner to achieve a desired target grade of material. Material can also be screened, bulk sorted or partial sorted to increase the overall quality of a total volume of raw material 122 so that is it at or above a tolerable quality threshold.

Further, in embodiments, the categorisation of raw material 122 will also be influenced by the physical properties of the raw material 122. For example, material can be dry or clayish depending on its moisture content, where an overly clayish material is undesirable due to its proclivity to clog up mining equipment. As such, there will generally be a minimum threshold of clayishness that is tolerable and will not significantly exacerbate the clogging of mining equipment. It will be appreciated that material that has a clayishness that is over the tolerable threshold are often blended with relatively dry material in order to reduce the overall clayishness so that is it at or below the tolerable threshold. Such a blending process can occur at the time of loading a truck, for example, a truck will receive material from loading device 130 where some is of a clayish nature and some is of a dry nature. The blending process can also occur at second location 108 where a specific dumping location can receive dumped material of a clayish nature from one of mine vehicles 102 and dumped material of a dry nature from another one of mine vehicles 102. Another important physical property of the raw material 122 that, in embodiments, is taken into consideration in regard to categorisation is fragmentation, that is the material being a small enough fragment size that is convenient to transport and process. Larger fragment sizes are often processed, for example, by a crusher in order to reduce the fragment size.

Within system 100, raw material 122 is categorised into three categories:
1) High grade material—that being material that is of a quality that is ready for processing such as sizing and/or concentration processes;
2) Low grade material—that being material that is of a quality where pre-processing activities must be applied to the material in order to convert it to high grade material; and
3) Waste material—that being material that is unsalvageable and entirely unfit for processing (which could be due to low levels of desired material, very high levels of deleterious materials, or a combination of both).

Second location 108 is generally a stockpile or other processing site. However, it will be appreciated that second location 108, in various embodiments, will refer to a plurality of sublocations within or external to a mine site. In such embodiments, each of the plurality of sublocations will only receive raw material 122 of a certain predefined material category. For example, in a preferred embodiment, second location 108 includes three sublocations: 1) a high grade material stockpile for the high grade category material, which may include a train loading dock 204 for transferring the high grade material to a processing plant or shipping port 206 as shown in FIG. 2; 2) low grade material stockpile for the low grade category material which may be a storage dump (as shown in FIG. 2) or include in itself, pre-processing equipment (noting that, practically speaking, such low grade material could be built up and remain for decades before pre-processing, given the majority of resources will be allocated to the higher grade material); 3) a waste dump for waste category material.

In embodiments, the low grade material stockpile includes a separating and/or concentration pre-processing equipment, which may be referred to as a pre-processing plant on the mine site. In other embodiments, blast site 106 will include in-pit operations such as in pit crushers, sizers or sorters which provide an early processing before the material is loaded into mine vehicles 102. In practical terms, the in-pit operations may be up to 2 kms to 4 kms from the initial location of raw material 122, and such in-pit operations are applicable to both high grade material and low grade material. For example, a crusher is used to break up high grade material even further that that caused by the blast, if size is an issue in respect of transportation and/or processing.

In yet other embodiments, material categories will differ from the above three categories. For example, in one embodiment, these are two material categories: waste material; and non-waste material. In another embodiment, there is a fourth material category in addition to the preferred three categories, that being a middle grade material category. In yet other embodiments, each of the preferred three categories may be divided into further subcategories depending on size such that larger sized material will go through an additional process to reduce the size (for example, through use of a crusher). In yet other embodiments, each of the preferred three material categories may be divided into further subcategories depending on dryness/clayishness such that each of the three material categories material will be subcategorised into dry or clayish. It will be appreciated that the specific categories chosen will depend on processing requirements such that each category relates to a considered material extraction process, that is, any category could be chosen if the mine site/plant is able to or has in place a process for that grade or quality of material.

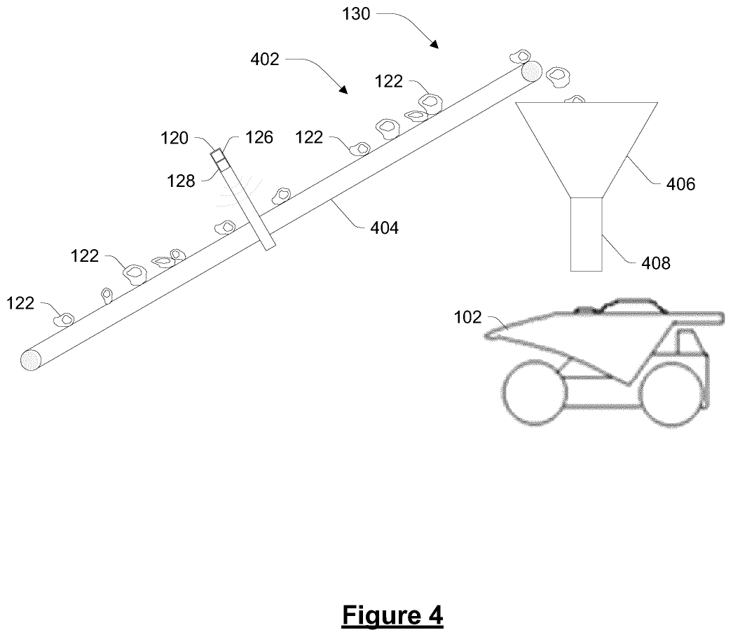

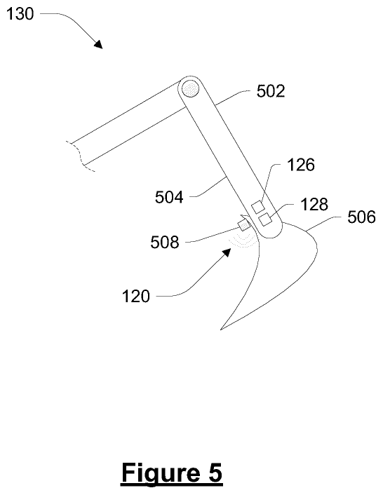

Referring to FIGS. 4 and 5, the loading system (which includes loading device 130) includes one or more pieces of equipment (which are individual loading devices akin to loading device 130) suitable for loading raw material 122 into the open-box cargo beds of the mine vehicles 102. In embodiments where mine vehicles 102 have flat beds or chassis that are configured to transport one or more cargo containers, loading device 130 is equally suitable to loading containers that are transportable by mine vehicles 102. Such one or more pieces of equipment includes, in various embodiments, excavators, dozers/loaders, face shovels, rope shovels, and conveyor loaders. In some embodiments, loading device 130 will be manually operated, but in other preferred embodiments such as FIG. 4 where loading device 130 including a conveyor loader 402, loading device 130 is automated and does not require manual control (other than to activate the conveyor loader). In yet other embodiments, loading device 130 will include a plurality of pieces of equipment where some are manually operated and some are automated. For example, loading device 130 could include a manually operated excavator for moving raw material 122 from blast site 106 to an automated conveyor loader which in turn loads raw material 122 into one or more of mine vehicles 102.

Referring to FIGS. 4 and 5, sensing device 120 is either mounted to (that is, retrofitted to) loading device 130 or integrally formed with loading device 130. Sensing device 120 includes a sensor processor 126 for processing the sensed information in order to grade raw material 122 and thereby determining the material category of raw material 122. Sensing device 120 also includes a sensor communications unit 128 coupled to sensor processor 126 for providing wireless communication (as explained above) with, amongst others, vehicle communications unit 304 of each of mine vehicles 102.

Conveyor loader 402 is essentially a feeder for feeding material into trucks. Conveyor loader 402 receives material from a shovelling device such as an excavator and direct the material towards and load the material into a waiting truck, thereby acting as an intermediary between the shovelling device and truck to alleviate the burden of directly loading the truck from the shovelling device. Conveyor loader 402 greatly improves the efficiency of loading.

Referring to FIG. 4, conveyor loader 402 includes a conveyor belt 404 and a hopper 406 wherein conveyor belt 404 transfers raw material 122 to hopper 406 which funnels raw material 122 into one of the plurality of mine vehicles 102. Sensing device 120 is positioned such that it senses chemical properties of raw material 122 on conveyor belt 404. In this embodiment, sensing device 120 is also configured to control conveyor loader 402 such that it will automatically activate and deactivate conveyor belt 404 as required (more on this below), or open and close a chute 408 of hopper 406 to respectively allow or prevent loading. In embodiments, conveyor loader 402 includes a diverter and multiple conveyor belts and hoppers such that raw material 122 is sensed on a first conveyor belt and then a diverter is used to divert material to different hoppers and/or conveyor belts based on the determined category of raw material 122 for subsequent loading into different ones of mine vehicles 102.

In other embodiments, conveyor loader 402 can be replaced by any buffer device that, within the process stream, sits between loading device 130 and mine vehicle 102. Such buffer devices take the form of any piece of machinery that is aimed at efficiently receiving raw material from loading device 130 and feeding it into mine vehicle 102, for example MMD's Surge Loader®. In embodiments, like conveyor loader 402, the buffer device includes sensory logic such that the buffer device is a material buffer with material selection and diversion capabilities. Like conveyor loader 402, the material buffer is informed by material property sensing devices and associated computer processing of any sensed material properties. Buffer devices such as conveyor loader 402 are able to:
Carry or transport material a distance before ultimately loading it into mine vehicle 102, such a distance being anywhere within the range of a few metres up to 100 metres or more, for example, to the edge of a pit or via angle conveyors to higher levels in a mine;
Hold a certain amount of material, so that material can be loaded onto the buffer device without having to immediately have to unload some material into a truck, for example, buffer devices hold three to four truckloads of material while waiting for a truck to arrive thereby allowing time for trucks to arrive and/or allowing for a loaded truck to depart and an empty truck to arrive without stopping the loading of the buffer device; and
Provide the benefit of decoupling two processes (unloading and loading), thereby removing the dependency between one action (unloading of loader) and the other (loading into truck).

Referring to FIG. 5, in other embodiments where loading device 130 includes an excavator 502, only partially illustrated showing a distal end of an arm 504 which is attached to a bucket 506, (or other loader with a similar bucket loading component) sensing device 120 takes the form of a bucket sensor 508 for sensing each load of raw material 122 that is picked up by excavator 502. In other embodiments, where loading device 130 includes both excavator 502 and conveyor loader 402, only sensing device 120 on the conveyor loader is used to sense and categorise raw material 122 after it has been loaded onto conveyor belt 404 by excavator 502. In other embodiments where loading device 130 includes both excavator 502 and conveyor loader 402, bucket sensor 508 is used to sense and categorise raw material 122 whilst it is loading it onto conveyor belt 404.

Sensing device 120 includes one or more sensors with the type of sensor including PGNAA (Prompt Gamma Neutron Activation Analysis) sensors, microwave sensors, x-ray sensors, and magnetic induction sensors, amongst others. Sensing device 120 senses the chemical properties of raw material 122 to ascertain the amount of desired (for example, iron mineralisation in rock), undesired material (for example, phosphor, sulphur content etc.) and physical properties (for example, fragmentation size, moisture content etc.)

Sensing device 120 is configured to sense the concentration of desired material referred to as (for example, iron, coal, etc.) in raw material 122. For example, if the desired material is iron, sensing device 120 is configured to sense the concentration of iron mineralisation in raw material 122. As will be appreciated by those skilled in the art, the term “grade” as used in relation to, for example, a “metal-containing material” is understood herein to be a term that is dependent on currently available technology and the current price of the particular metal, and that material currently considered “low grade” may be considered valuable material in the future depending on technological developments and the future price of the metal.

In alternate embodiments, sensing device 120 is configured to sense either the concentration of desired material or the concentration of deleterious material. In yet other embodiments where sensing device includes multiple sensors, for example the bucket sensor and the sensor on conveyor belt 404, one of those will sense the concentration of desired material and the other will sense the concentration of deleterious material.

In various embodiments, various sensing methodologies (and combination thereof) are be used to obtain knowledge of material properties both during and after drilling, and during excavation. In these and other embodiments, the material category is estimated based on knowledge of the bench of blast site 106 obtained prior to blasting. Examples include:
Measurement-while-drilling (MWD) data that will be obtained during a blast hole drilling process which, along with other tools and further extrapolation techniques, will provide concentration of desired and/or undesired materials in each block of the bench, in order for each block to be designated a material category;
Blast cone sampling; and
hyperspectral imaging, techniques of which are discussed in more detail in the following patent publications: PCT publication WO2016/112430 entitled “Hyperspectral Imager Method and Apparatus” published on 21 Jul. 2016; PCT publication WO2011/094818 entitled “Determination of Rock Types by Spectral Scanning” published on 11 Aug. 2011; and Australian patent 2009200859 entitled “Scanning System for 3D Mineralogy Modelling” published on 24 Sep. 2009.

Whilst each block is categorised, after blasting of adjacent blocks, the boundaries of those adjacent blocks will contain blasted material from each of the two adjacent blocks. Therefore, the categorisation of material disposed at those boundaries will be a mix of the categories of the adjacent blocks and, which may present an issue in cases where the categories of the adjacent blocks are different. In such scenarios, both pre-sensing prior to blasting for material of a block that is a sufficient distance from the boundary and active sensing following blasting during the loading process for material of at or within a certain distance of the boundary is used so that the more uncertain raw material 122 at the boundary is actively sensed as the category could be that of either adjacent block and this will almost certainly vary through the raw material at the boundary. As such, this ensures accuracy of categorisation of all raw material 122 include that at the boundary of adjacent blocks.

Sensing device 120 is also in communication, via sensor communications unit 128 with the central controller of mine site 104. In various embodiments, sensor communications unit 128 communicates directly with vehicle communications unit 304 or must communicate with vehicle communications unit 304 via the central controller of mine site 104. In preferred embodiments, sensor processor 126 will instruct a specific one of mine vehicles 102 to proceed to a specific second location 108 based on the category of raw material 122 determined by sensor processor 126 that is loaded into that specific one of mine vehicles 102.

In some embodiments, sensing device 120 is configured to sense raw material 122 and communicate that raw sensed data to the central controller of mine site 104 where it is processed in order to grade raw material 122 and thereby determining the material category of raw material 122. Based on the determined material category, the central controller of mine site 104 will then instruct a specific one of mine vehicles 102 to proceed to a specific second location 108 based on the category of raw material 122 (determined by the central controller of mine site 104) that is loaded into that specific one of mine vehicles 102. In yet other embodiments, the central controller of mine site 104 will communicate the determined material category to controller 302 of a specific one of mine vehicles 102. Controller 302 will then, based on the determined material category, instruct that specific one of mine vehicles 102 to proceed to a specific second location 108 based on the category of raw material 122 that is loaded into that specific one of mine vehicles 102.

In embodiments where sensor communications unit 128 communicates with vehicle communications unit 304 via the central controller of mine site 104, a mine vehicle is able to commence travel away from blast site 106 in the general direction of second location 108 (in reality, there may be only one predefined route to travel) and the specific second location 108 based on the category of raw material 122 that is loaded into that specific one of mine vehicles 102 can be determined en route as the distance and route between blast site 106 and second location 108 will be such that providing instructions en route will not at all delay the transportation of raw material 122 in mine vehicles 102. In this case, the material category is generally determined by sensor processor 126 so that a single category of raw material 122 is loaded into any one of mine vehicles 102. Further, mine vehicles 102 can be redirected mid-journey to another location that also processes material of the grade that is being carried by that mine vehicle.

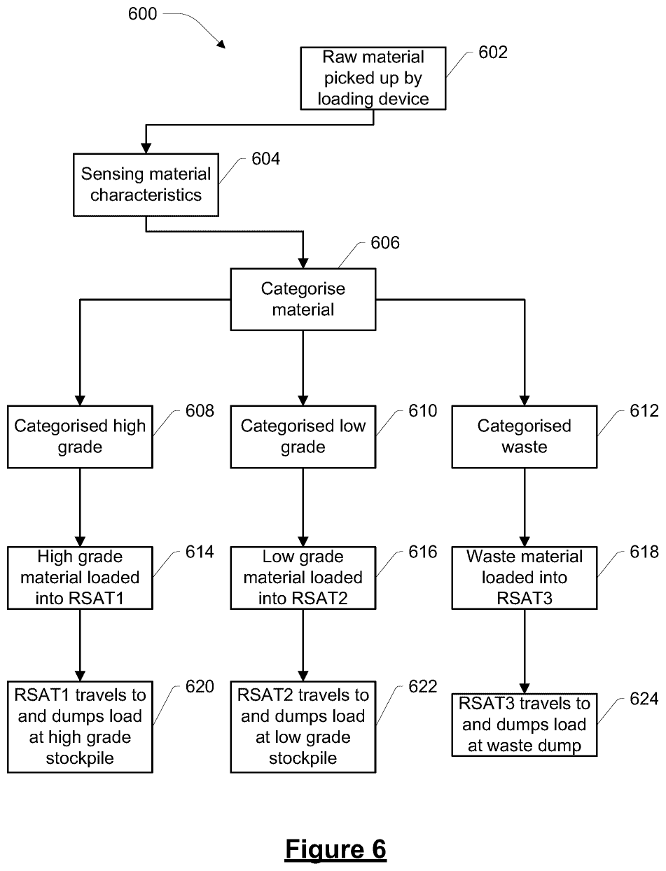

Referring to FIG. 6, there is illustrated a process for categorising, loading and transporting raw material 122, the process denoted by reference 600. At 602, loading device 130 picks up raw material 122 from blast site 106. At 604, whilst raw material 122 is held by loading device 130, sensing device 120 actively senses characteristics of raw blasted mined material 122. At 606, sensor processor 126 categorises raw material 122, based on the sensed characteristics, into one of the following material categories: high grade material at 608; low grade material at 610; and waste material at 612. It will be appreciated that at 606, in some embodiments, sensing device 120 also determines other chemical properties of raw material 122 such as dryness/clayishness and concentration of deleterious materials.

Based on that categorisation, each of mine vehicles 102 will be loaded such that each individual vehicle only carries raw material 122 of one material category, denoted by references 614, 616 and 618 which respectively denote loading separate mine vehicles 102, labelled in FIG. 6 as RSAT1, RSAT2 and RSAT3 with high grade material, low grade material, and waste material, respectively. It will be appreciated that each of empty mine vehicles 102 (RSAT1, RSAT2 and RSAT3) could be loaded with any single material category of raw material 122, but for illustrative purposes only, each of RSAT1, RSAT2 and RSAT3 is respectively loaded with high grade material, low grade material, and waste material. Practically speaking, any one of mine vehicles 102 is loaded with whatever category of raw material 122 is in loading device 130 at the time the mine vehicle is ready to receive the material.

It will be appreciated that, in preferred embodiments, the loading of mine vehicles 102 is not influenced by sensed dryness/clayishness and concentration of deleterious materials. However, these properties are recorded for each load within each of mine vehicles 102 for future purposes, for example, including formulating a “map” of second location 108 of precise locations where loads are dumped. For example, a certain sub-area of second location 108 (say, the north side) is dumped with a certain category with certain quality properties, such as high-phosphor, low-clay material, and another certain sub-area of second location 108 (say, the south side) is dumped with another certain category with certain quality properties, such as high-phosphor, high-clay material.

In alternate embodiments, each of mine vehicles 102 is preassigned to receive a specific material category of raw material 122, that being RSAT1 preassigned to high grade material, RSAT2 preassigned to low grade material and RSAT3 preassigned to waste material. Further, sensor communications unit 128 will communicate directly with vehicle communications unit 304 of each of mine vehicles 102 to instruct them to proceed to a specific second location 108 based on the material category of each mine vehicle's load of raw material 122.

It will be appreciated that, as each individual mine vehicle 102 is only loaded with raw material 122 of a single material category, this may mean that one or more of mine vehicles 102 is not completely filled up if the volume of raw material 122 of a certain material category is less than the full capacity of a mine vehicle. Each of mine vehicles 102 will set off from blast site 106 either when it has been filled to full capacity or when the raw material 122 being loaded changes to a different material category. For example, in the embodiment of FIG. 4, sensing device 120 on conveyor loader 402 will sense raw material 122 on conveyor belt 404 and whilst raw material 122 is the same material category and mine vehicle 102 is not at full capacity, conveyor belt 404 will continue transfer raw material 122 to hopper 406 to load mine vehicle 102. However, once sensing device 120 determines that the material category changes or once that mine vehicle 102 has reached full capacity, sensor processor 126 will instruct conveyor belt 404 to deactivate until mine vehicle 102 has moved from under hopper 406 away from blast site 106 and the next empty mine vehicle 102 positions itself under hopper 406 after which conveyor belt 404 is activated and the loading commences into that next mine vehicle 102. In other words, the loading of one of mine vehicles 102 is stopped when the material category changes (in the case of loading from hopper 406 already containing material, loading is stopped after an estimate of when the change in material category would occur) or when that one of mine vehicles 102 is full. Therefore, in some cases a mine vehicle will only be partially loaded should a change in material be sensed. For example, if raw material 122 being loaded into mine vehicle 102 is of a high grade but that part way through loading of mine vehicle 102 the material being loaded is sensed as changing to low grade material, the loading of that mine vehicle will cease with mine vehicle 102 only partially filled. In embodiments using chute 408, the chute is opened or closed to effect the cutting off of the loading operation. For example, if hopper 406 is currently one third full and a change in material categorisation is detected by sensing device 120, if sensing device 120 is positioned halfway along conveyor belt 404 that feeds hopper 406 (and the density of raw material 122 along the half of conveyor belt 404 downstream of sensing device 120 is known), then chute 408 will be controlled to close once the raw material 122 in the third of hopper 406 and the additional raw material 122 on the downstream half of conveyor belt 404, has been loaded into one of mine vehicles 102.

It will be appreciated that in some cases, it may not be feasible to deactivate conveyor belt 404 given that this may also necessitate, for example, stopping excavator 502 from loading material onto conveyor loader 402. As such, the use of toggling the opening and closing of chute 408 is preferable in taking advantage of conveyor loader 402 as a buffer to enhance efficiency of the overall loading process.

In some embodiments, two or more of RSAT1, RSAT2 and RSAT3 are loaded simultaneously or substantially simultaneously with their respective high grade material, low grade material, and waste material. For example, in an embodiment where RSAT1 and RSAT2 are loaded simultaneously, RSAT1 and RSAT2 position themselves to receive raw material from their own predefined one of two hoppers and conveyor belt 404 includes a diverting mechanism that is configured to divert material of a certain grade to the desired hopper such that high grade material will be diverted to the hopper where RSAT1 receives that material and low grade material will be diverted to the hopper where RSAT2 receives that material. In yet other embodiments, there are two hoppers such that high and low grade material is diverted by a diverting mechanism to one hopper where RSAT1 or RSAT2 are positioned to receive their respective high and low grade material (at different times, not simultaneously) and the waste material is diverted to the other hopper for discarding onto the ground where it is subsequently dozed. In this embodiment, the other hopper that receives the waste material may be spaced apart from the hopper that directs the high and low grade material respectively into RSAT1 and RSAT2 so that the discarded waste material is dumped at a distance that does not affect RSAT1 and RSAT2. In yet other embodiments where two or more RSATs carry the same category of material, a diverter can be used to simultaneously load multiple trucks with the same category of material.

After mine vehicle 102 sets off from blast site 106, at 620, mine vehicle 102 carrying high grade material travels to its specific second location 108 (also referred to as a high grade material location having a high grade material stockpile), in this case a stockpile for a train loading dock, and dumps its load of raw material 122 at its specific second location 108. At 622, mine vehicle 102 carrying low grade material travels to its specific second location 108 (also referred to as a low grade material location having a low grade material stockpile), in this case a stockpile for a pre-processing plant, and dumps its load of raw material 122 at its specific second location 108. At 624, mine vehicle 102 carrying waste material travels to its specific second location 108 (also referred to as a waste material location having a waste dump), in this case a waste dumping ground, and dumps its load of raw material 122 at its specific second location 108. It will be appreciated that, following 620, 622 and 624, controller 302 will inform central controller of mine site 104 that the load of raw material 122 of its category has been dumped, whereby central controller of mine site 104 can then update the “map” of second location 108, that is, update characteristics of the stockpile such as volume, mineral properties, etc.

It will be appreciated that a number of optional steps are included in other embodiments, including:
Prior to 602, a crusher is utilised for fragmentation of raw material 122 so that it is better suited to efficient transportation and/or efficient processing. Similarly, a sorter is utilised to sort pieces of raw material 122 by size such that pieces of a certain size or less are prioritised for loading onto mine vehicles 102.
Following high grade material at 608, low grade material at 610, and waste material at 612, respectively subcategorising these into dry and clayish and, following this subcategorising blending of dry and clayish materials at a predefined ratio so as to produce material of a tolerable dryness/clayishness.

It will be appreciated that, based on conventional thinking, using smaller sized haul trucks (in this case RSATs) instead of much larger ultra-class haul trucks would not be considered given the significant decrease in per truck, per journey capacity. Further, the use of a greater number of smaller haul trucks to offset the above size constraints would also not fall in line with conventional thinking as this would result in a perceived increase in labour costs due to an increase in the total number of vehicles potentially requiring a greater number of drivers or supervisory personnel, greater road traffic that will be an issue on mine sites where road space is limited, increased wear on roads and increased potential for vehicle crashes.

### Advantages of Detailed Embodiments

It will be appreciated that the embodiments of material categorisation and transportation system 100 described herein are advantageous over known systems as it achieves the following advantages:
Allows for partial loading of mine vehicles 102, where in conventional systems involving the use of ultra-class haul trucks, the partial loading of a truck is not considered because each truck load represents a substantial percentage of the overall volume of material transported. Thus, partially loading an ultra-class haul truck would noticeably reduce the overall volume of material transported and, hence, the efficiency of each truck. In contrast, by using a large fleet of RSATs as mine vehicles 102, the partial loading of a single RSAT so as not to dilute/contaminate its load represents a negligible impact on overall volume of material transported. As such, the use of partially loaded smaller haul trucks becomes economically feasible because the “lost opportunity” of partially loading one out of a large multitude of smaller haul trucks is much less than that of partially loading one out of a very small number of ultra-class haul trucks.
Even if the load of one RSAT mine vehicle 102 happens to be diluted and/or contaminated, the magnitude of this dilution and/or contamination is restricted to just that one RSAT's load-volume, which is significantly smaller than the load-volume of an ultra-class haul truck.
Whilst one ultra-class haul truck can carry the equivalent of two to six RSATs, in terms of cost, one ultra-class haul truck is far more expensive to purchase, run and maintain than two to three RSATs. This is due to RSATs being of a conventional size and therefore only requiring easily attainable conventional parts and conventional maintenance facilities. On the other hand, ultra-class haul trucks require bespoke spare parts that are much more difficult to obtain, and bespoke facilities and equipment for running and maintenance.
The use of RSATs that have a greater range than ultra-class haul trucks will allow for different and more efficient mine layouts. For example, for a mine site having multiple pits, instead of each pit having its own dedicated stockpile that is within a certain limited range of the pit (that range based on the maximum safe range of ultra-class haul trucks) the mine site could have a single central stockpile at a greater distance from each pit where all material is consolidated. Similarly, a mine site having multiple pits could also be arranged so that there is a single processing facility and/or outbound logistical facility (such as trains).
The use of RSATs over ultra-class trucks will enable more economic mining of an ore deposit and more selective mining. In other words, material can be mined that may be otherwise be left behind.
The use of conventionally-sized trucks such as RSATs allow access to more areas of a mine site. In other words, the small sized vehicle will be able to access areas of the mine site (such as remnant areas) which would otherwise be inaccessible for ultra-class trucks due to their significantly greater size.
Improved discrimination between high and low grade blasted material by using smaller sized haul trucks which naturally results in less dilution and/or mixing of high grade, low grade and waste material. Since ultra-class haul trucks must be completely filled in order to facilitate transport efficiencies, a call must be made on the grading of the material of the entire load which will limit the accuracy of that overall grading given the great amount of material and the potential need to load a single ultra-class haul truck with materials of different gradings. The use of RSATs that do not need to be completely filled will not force such a call to be made as the loading of a truck will simple cease when there is no more material of a certain material category to load. This provides an improved resolution of payloads which in turn provides a higher resolution of stockpiles with little dilution and much lower chance of non-waste material being graded as waste material.
Dynamic re-direction of loads in smaller trucks to different destinations based on chemical properties of the load. This is possible due to the chemical properties being sensed by sensing device 120, and further because the small loads of each mine vehicle 102 means that the properties of each truck load are more homogenous (and hence meaningful) as compared to the load of a much larger ultra-class haul truck.
Further, mine vehicles 102 can be redirected mid-journey which will be advantageous in certain circumstances, for example: if more information being processed that takes time, or information is processed offsite or remotely (such as a cloud model) and the result comes back to divert certain mine vehicles 102 to a different destination location; or information from one of mine vehicles 102 at another loading point influenced the target for another one of mine vehicles 102.
Sensing raw material 122 at the time of excavation and/or loading enables material properties to be tracked per load with an external data system (which would be in communication, via a network, to the central controller of mine site 104, sensor processor 126, and controller 302). Current stockpiles are a blend of many materials with limited knowledge of the chemical composition.
Having knowledge of material properties can be used to decide on how stockpiles are built. That is, by digitally tracking where each truck load is dumped and recording the material properties that are measure by system 100 at the excavation process for each load, a digital “map” of the stockpile can be constructed. When the stockpile is reclaimed, this map is used to select a specific sequence and/or target specific chemical and physical properties to optimise blending and/or productivity of the plants.
A range of smaller stockpiles can be built, which can pre-sort raw material 122 based on certain chemical and physical properties (for example, low phosphorous, low silica, fragmentation etc.) thereby producing a range of stockpiles that form a material “menu” where specific material can be picked as needed at a processing plant or for a down-stream process.
There is a minimisation of wastage which is particularly important given that, over time, the general quality of ore has reduced significantly and therefore minimising wastage is becoming more important than ever. It is noted that conventional systems using ultra-class haul trucks (that require use of full truck capacity and potentially a number of trucks in a relay type arrangement to carry a single load cover longer distances) are much more susceptible to wastage due to necessary rehandling.
The use of RSATs as part of the system provides a complete autonomous system. From the sensing and resultant categorisation of the raw material to the transportation of the categorised material to the remote location (such as stockpiles, sorting facilities, crushing facilities, etc.), this can be done without the need for human intervention, or with little or vastly reduced human intervention. Furthermore, autonomous RSATs can be provided with a command to be redirected mid-journey which, again, could be carried out without human intervention.
The use of electric vehicles provides several advantages in terms of power efficiencies and environmental advantages. Firstly, conventional sized trucks are easier to “electrify” in the sense that the larger the truck, the larger the battery will be that is required to power it, or the more batteries will be required to power it.
The use of conventional sized trucks may also provide a 20% to 30% saving on fuel and energy consumption as compared to ultra-class trucks to move a certain payload (per ton moved).
The use of conventional sized electrical trucks is also beneficial in that a smaller mining footprint. That is, the minimum mining width requirement is reduced and the minimum space required in order create an economical hole in the ground is reduced. Further, there will be a smaller mining footprint overall to extract a certain amount of ore as compared to mining with ultra-class trucks. The flow on impacts of this includes reduced social license to operate and reduced mine closure impacts closure aspects includes reduced costs for mine closure.

As such, system 100 provides significant advantages and improvements over known systems in terms of accuracy of material grading and categorisation and minimisation of wastage.

### Conclusions and Interpretation

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

Throughout this specification, where used, the terms “element” and “component” are intended to mean either a single unitary component or a collection of components that combine to perform a specific function or purpose.

It should be appreciated that in the above description of exemplary embodiments of the invention, various features of the invention are sometimes grouped together in a single embodiment, Figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Unless specifically stated otherwise, as apparent from the following discussions, it is appreciated that throughout the specification discussions utilizing terms such as “processing,” “computing,” “calculating,” “determining”, analysing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, for example, from registers and/or memory to transform that electronic data into other electronic data that, for example, may be stored in registers and/or memory. A “computer” or a “computing machine” or a “computing platform” may include one or more processors.

Some methodologies or portions of methodologies described herein are, in one embodiment, performable by one or more processors that accept computer-readable (also called machine-readable) code containing a set of instructions that when executed by one or more of the processors carry out at least one of the methods described herein. A memory subsystem of a processing system includes a computer-readable carrier medium that carries computer-readable code (for example, software) including a set of instructions to cause performing, when executed by one or more processors, one of more of the methods described herein. Note that when the method includes several elements, for example, several steps, no ordering of such elements is implied, unless specifically stated. The software may reside in the storage medium, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, unless otherwise specified, the one or more processors operate as a standalone device or may be connected, for example, networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while only a single processor and a single memory that carries the computer-readable code may be shown herein, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein, unless otherwise specified.

Thus, one embodiment of each of the methods described herein is in the form of a computer-readable carrier medium carrying a set of instructions, for example, a computer program that is for execution on one or more processors, for example, one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, for example, a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (for example, a computer program product on a computer-readable storage medium) carrying computer-readable program code embodied in the medium.

The software may further be transmitted or received over a network via a network interface device. While the carrier medium may be shown in an embodiment to be a single medium, the term “carrier medium” should be taken to include a single medium or multiple media (for example, a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fibre optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage.

### INDUSTRIAL APPLICABILITY

The arrangements described are applicable to the mining industry and, particularly to haulage of blast mining materials. Thus, the invention is clearly industrially applicable.

1. A material categorisation and transportation system including:
at least two mine vehicles having an autonomous mode of operation for at least partially autonomously transporting material from a first location to a second location;
a sensing device for sensing characteristics of material such that the material is categorised into one of at least two material categories based on the sensed characteristics; and
a loading device located at the first location for loading material into the at least two mine vehicles based on the material category for transportation of the material to the second location, such that each of the at least two mine vehicles will only carry material of one of the at least two material categories.

2. The system according to claim 1 wherein the sensing device is mounted to the loading device.

3. The system according to claim 1 wherein the sensing device is integrally formed with the loading device.

4. The system according to claim 1 wherein the sensing device is operatively associated with the loading device such that it can activate and deactivate the loading device from loading material.

5. The system according to claim 1 wherein the mine vehicles are haul trucks of a conventional size range of vehicles that generally travel on public roads.

6. (canceled)

7. The system according to claim 5 wherein the haul trucks have a load capacity in the range of 10 tonnes to 80 tonnes.

8. The system according to claim 7 wherein the haul trucks have a load capacity in the range of 40 to 60 tonnes.

9. The system according to claim 1 wherein the sensing device includes at least one sensor, the at least one sensor being one or more of the group including: Prompt Gamma Neutron Activation Analysis (PGNAA) sensor; microwave sensor; x-ray sensor; and magnetic induction sensor.

10. The system according to claim 1 wherein the loading device one or more of the group including: an excavator; a dozer; a face shovel; a rope shovel; and a conveyor loader.

11. The system according to claim 1 wherein the characteristics of material sensed by the sensor device include one or more of:
concentration of a desired material; concentration of deleterious material; material moisture content; and material fragmentation size.

12. The system according to claim 1 wherein the material is categorised into one of a plurality of material categories based on the sensed characteristics.

13. The system according claim 12 wherein the plurality of material categories includes: a high grade material category; a low grade material category; and a waste material category.

14. The system according to claim 13 including at least three mine vehicles wherein:
a first one of the at least three mine vehicles receives material of the high grade material category;
a second one of the at least three mine vehicles receives material of the low grade material category; and
a third one of the at least three mine vehicles receives material of the waste material category.

15. The system according to claim 14 wherein the first one of the at least three mine vehicles is configured to transport the material of the high grade material category to a high grade material location, the second one of the at least three mine vehicles is configured to transport the material of the low grade material category to a low grade material location, and the third one of the at least three mine vehicles is configured to transport the material of the waste material category to a waste material location.

16. The system according to claim 1 wherein the first location is a blasted mine bench on a mine site.

17. The system according to claim 1 wherein the second location is a stockpile associated with a materials processing site.

18. The system according to claim 1 wherein the second location includes a plurality of sublocations such that each sublocation receives only materials of a certain one of the material categories.

19. The system according to claim 1 wherein the loading device is configured to cease loading one of the at least two mine vehicles if the category of material that is sensed changes such that the one of the at least two mine vehicles is not loaded to its full capacity.

20. The system according to claim 19 wherein the one of the at least two mine vehicles that is not loaded to its full capacity is configured to commence transportation of the material to the second location.

21. (canceled)

22. The system according to claim 1 wherein each of the at least two mine vehicles are able to be re-directed, prior to arrival at the second location, to a third location.

23. The system according to claim 1 wherein the second location is not determined until after the at least two mine vehicles departs the first location.

24. A material categorisation and transportation method including the steps of:
sensing, by a sensing device, characteristics of material at a first location;
categorising the material into one of at least two material categories based on the sensed characteristics;
at the first location by a loading device, loading a predefined mine vehicle with material of a specific one of the at least two material categories, such that the predefined mine vehicle is only loaded with material of one of the at least two material categories; and
transporting, by the predefined mine vehicle, the material to a second location, wherein the predefined mine vehicle has an autonomous mode of operation and the transporting of material at least partially involves the mine vehicle being in the autonomous mode of operation.

25.-37. (canceled)
